(19) United States
(12) Patent Application Publication
(10) Pub. No.: US 2010/0307195 A1
(43) Pub. Date: Dec. 9, 2010

(54) DEVICE AND METHOD FOR PROCESSING SUBSTRATES HAVING LARGE SURFACE AREAS

(75) Inventor: Arthur Buchel, Ruggell (LI)

Correspondence Address: MORRISS OBRYANT COMPAGNI, P.C., 734 EAST 200 SOUTH, SALT LAKE CITY, UT, 84102, US

(73) Assignee: IWORKS AG, Ruggell (LI)

(21) Appl. No.: 12/863,178

(22) PCT Filed: Jan. 12, 2009
(86) PCT No.: PCT/CH09/00011

§ 371 Date: Jul. 15, 2010

(30) Foreign Application Priority Data
Jan. 15, 2008 (CH) 58/08

(51) Int. Cl. C03B 35/00; C03C 23/00; C03B 23/02

(52) U.S. Cl. 65/102; 65/286; 65/182.2

(57) ABSTRACT

A device for processing a usable surface extending on a usable side of a substrate (11) having a large surface area, particularly such having a length or width >0.5 m and a thickness <1 cm, through the substrate, has at least three bearing elements (21, 23, 25) disposed at a distance from each other for receiving the substrate (11), and a movable processing device for processing the substrate between the bearing elements from the rear of the substrate. The bearings support the substrate, and processing of the glass substrate can be carried out in the at least two intermediate regions between the bearing elements from the rear. At least one non-terminal bearing element is disposed displaceable or movable relative to the substrate in order to make the entire usable surface of the substrate accessible to the processing device by displacement or movement.

### CROSS-REFERENCE TO RELATED APPLICATIONS

This application claims priority to PCT/CH2009/000011 filed on Jan. 12, 2009 and CH58/08 filed on Jan. 15, 2008, the entirety of each of which is incorporated by this reference.

### BACKGROUND OF THE INVENTION

1. Field of the Invention

This present invention relates to a device and a method for processing a usable surface of substrates having a large surface area, in particular substrates having a length or width of >0.5 m and a thickness of <1 cm, with at least three bearing means arranged set apart from one another for receiving a substrate and a movable processing means for processing the usable surface of the substrate between the bearing means.

2. State of the Art

Processing from the usable side arranged on the upper side is advantageous for the processing of large, flat substrates, as the substrate can then be horizontally deposited on a base and can subsequently be processed from above in the X and Y direction over the entire usable area by means of a suitable processing means, for example a laser jet.

However, processing from the back of the glass can be more advantageous for certain processes. Thus, for example, the processing of the coated usable side of the glass substrate is typically carried out by means of a laser jet from the non-coated back of the glass substrate for laser ablation for the structuring of thin-layer silicon solar modules.

This gives rise to the problem that the substrate, if it is mounted horizontally on the edge of the substrate and is of a size which is beneficial for commercial use (length or width >0.5 m, thickness <1 cm), sags considerably as a result of its own weight. The sagging impedes processing, as the distance between the processing means and the substrate, for example the laser optics lens and the underside of the glass, should not change for precise processing.

In order to solve this problem, solutions according to FIG. 1 are currently conventional; these solutions have for the substrate 11 a rest table 13 having a narrow gap 15 in the centre of the table that extends at right angles to the movement of the substrate. The substrate 11 is guided beyond the table 13 in the Y direction 17 (=direction of conveyance) without sagging. One or more displaceable processing means are arranged in the gap 13, whereby processing in the X direction as indicated by arrow 19 from the back of the substrate is made possible by moving the processing means and in the Y direction by moving the substrate and the entire usable surface can thus be processed. For moving the substrate 11, the rest table 13 has a bearing arrangement which conventionally consists of an air bearing or of a conveyor belt.

However, this arrangement has the drawback that the relatively heavy substrate has to be moved during the processing. This has the consequence that a) the processing installation is increased in size and long linear axes are necessary and b) the high mass of the substrate produces high acceleration forces which can lead to inaccuracies and/or necessitate additional measures to compensate for the acceleration forces, thus making the arrangement complex and expensive.

JP 2001111078 discloses a device for manufacturing a thin-film solar cell, with which a substrate is held, in order to clamp it with as flat a surface as possible, along the rims in a flat orientation and is supported in the surface at certain points by support structures. These support structures are positioned at points which are not processed. The thin layer is processed by means of laser from the upper side and the thin layer rests on the supported underside.

A device for processing thin-film solar cells is known from JP 06326337. A transparent rest, right through which the thin layer, which is present on the upper side of the substrate, is processed from the underside, is provided for supporting the substrate. Air channels, which allow the substrate to be sucked onto the substrate and as a result to be fixed in its position, are formed in the rest. In an alternative embodiment of the transparent rest, the rest is provided with recesses right through which the coating of the substrate is processed. In this case, the rest can be made of a non-transparent material. According to FIGS. 1 and 2, the laser beam is used to produce an individual linear structure merely between the air channels, so that the recesses in the non-transparent recesses need merely provide space for an individual linear structure. This device has the drawback that the transparent glass plate becomes very thick, specifically in substrates having a large surface area. Another drawback is the fact that, if non-transparent bearings are used in large substrates (length or width of >1 m), a substantial part of the usable surface of the substrate is not accessible for processing and merely individual laser lines can be drawn between the bearing means.

Starting from this prior art, the invention provides an inexpensive, efficient solution for processing the backs of substrates having a large surface area.

### SUMMARY OF THE INVENTION

The device for processing substrates having large surface areas from the back of the substrate has in a known manner more than two bearing means arranged set apart from one another for receiving a substrate and a movable processing means for processing the substrate between the bearing means from the back of the substrate. The term “substrates having a large surface area” refers in particular to substrates having a length or width of >0.5 m and a thickness of <1 cm.

Now, according to the invention, a displacement means is provided in the device to achieve a relative displacement between at least the non-terminal bearing means and the substrate. This means that the regions which are subjected to stress by the bearing means before the displacement are accessible for processing after the displacement. There are two possible embodiments for this, namely a first embodiment in which, of the at least three bearing means, at least one non-terminal bearing means is arranged displaceably or movably so that the entire usable surface of the substrate can be made accessible to the processing means by displacing or moving the bearing means, or else a second embodiment in which the displacement means is a conveying device by means of which the substrate can be displaced by at least the bearing width, again so that the entire usable surface of the substrate can be made accessible to the processing means by displacing or moving the substrate.

In this case, it is for the time being immaterial whether the bearing means supports the substrate on the coated usable side or on the uncoated back or both sides. In both cases, the regions which are subjected to stress by the bearing means become accessible only owing to the relative displacement for processing from the back, as the regions to be processed may not be covered on the coated usable side during the laser processing. This therefore allows the bearing means to be arranged over or under the substrate and the substrate to be processed from the back in both these cases, regardless of whether this uncoated back is now the upper side or the underside of the substrate. These four variant embodiments are easy to implement in particular when merely non-marginal bearing means are displaceable. The bearing means can in this case be arranged under the substrate, so that the substrate is pressed onto the bearing means by gravity. If the bearing means are embodied in the manner of suction strips in accordance with JP 06-326337, the bearing means can be arranged both under and over the substrate and the substrate can be held by the reduced pressure prevailing in the suction strips, if appropriate counter to gravity.

All that matters in the invention is that a plurality of intermediate regions between the bearing means can be processed and, after a relative displacement between at least one non-terminal bearing means and the substrate, the region of the usable surface that was concealed by the at least one bearing means before this displacement can also be processed. Generally, this requires just one displacement, although a plurality of displacements could also be carried out.

This has the advantage that high precision of the processing of the usable surface can be achieved. Advantageously, merely the non-terminal bearing means are displaced for the relative displacement.

Expediently, the usable side is arranged on top and the processing takes place from below right through the substrate.

If three or more bearing means are provided, two of which support the substrate at the edge during the processing process, and at least one non-terminal bearing means is displaceable in the direction of conveyance of the substrate, the entire substrate surface becomes processable and accessible to the processing means as a result of the displacement of the displaceable bearing means. This means that the back of the substrate can be processed even in the regions in which the substrate is supported without moving the substrate itself in the Y direction. This means a considerable saving in costs, weight and space. The processing precision also increases, as the substrate rests with respect to the marginal bearing means during the processing process.

Advantageously, a means is provided for moving the displaceable or movable bearing means. The bearing means can be horizontally displaced by means of a linear motor, for example. In addition, a vertical movement of the bearing means can be provided before and after the displacement of the bearing means. The raising of specific bearing means in the intermediate region between the terminal bearing means and subsequent lowering and/or displacement of the one or more bearing means previously in use allows the back of the substrate to be processed over its entire surface area without moving the substrate itself.

The processing means is movable in the direction of conveyance of the substrate and transversely thereto (X and Y direction), so that processing is possible from the back of the substrate in the respectively accessible regions between the movable bearing means.

Expediently, the processing means is movable in the direction of conveyance of the substrate (if there is such a substrate) and transversely thereto (X and Y direction). Owing to the two directions of movement lying perpendicularly to each other, processing from the back of the substrate is possible in the entire respectively accessible regions between the bearing arrangements. In one embodiment, the processing means is equipped with one or more laser sources, so that the substrate can be simultaneously processed with one or more laser beams. The movements of the processing means and the movable bearing elements can be mechanically coupled.

The device has a rotary means which can be guided to the substrate in order to grasp it and in order to rotate it about the centre of the usable side or the back of the substrate, i.e. in the region of the centre of gravity thereof, through +/−90° about an axis perpendicular to the usable surface thereof. This allows processing of the substrate to be uninterruptedly carried out over their entire length using the processing means both in the x and in the y direction. The rotary means can be arranged below the substrate or else be located above the substrate. In addition, it can be embodied as a conveying means and serve to convey the substrate from the loading position to the processing station and onwards into the unloading position in that it is additionally equipped with a linear drive. If the rotary means is arranged on the back of the substrate (this is generally under the substrate), a vacuum suction method is advantageous for fastening the substrate on the rotary means for carrying out the rotational or the sliding movement. If the rotary means grasps the substrate at the usable side, in particular is arranged above the substrate, a combination of suction/air bearings or a Bernoulli bearing arrangement can be used in order to avoid a contact with the risk of infringing the usable surface. Alternatively thereto, the rotary means can clamp the substrate at the ends in order to ensure that the substrate is held without contact with the usable side.

Mounting the substrate on the back has the advantage that the usable side is free from obstructing bearing means over its entire surface area for monitoring, further processing, extraction of ablated material by suction, etc.

The present invention also relates to a method for processing a usable surface extending on the usable side of a substrate, in which method the substrate is fixed during a processing process so as to be positionally stable in three or more bearing means, and processed from the back of the substrate opposing the usable surface by means of a processing means, for example a laser source, right through the substrate and the processing zone is at the same time optionally accessible on the usable side for monitoring or extraction of the ablated material by suction, for example. According to the invention, in a method of this type for processing the regions of the usable surface that are covered by the bearing means, the relative position of the substrate in relation to at least the non-terminal bearing means is displaced by at least the width of the bearing means and the regions of the usable surface that have not yet been processed are then processed.

What is particularly advantageous is a method for processing a substrate, in which method the substrate is deposited on bearing means and processed from below by means of a processing means, for example a laser source, which method is characterised in that the substrate is deposited on three or more bearing means arranged set apart from one another and can rest in a positionally stable manner on the bearings during the processing process and in that, for processing the usable surface covered by the bearings, the position of the substrate in relation to the bearing is displaced by at least the width of the bearings, but should be at most by a distance corresponding to the spacing of the bearings from one another, so that the usable surface which has not yet been processed can then be processed.

In one embodiment, the method is distinguished in that the substrate remains in a fixed position and the bearing means are displaced in order to make the previously covered regions of the usable surface accessible. However, on the other hand, the bearing means can also remain in a fixed position and the substrate be displaced in order to make the previously covered regions of the usable surface accessible.

Furthermore, both the bearing means and the substrate can also be displaced in order to make the previously covered regions of the usable surface accessible.

In the method, the processing means is advantageously moved for processing the substrate in two intersecting directions (X and Y direction). Expediently, the processing means is also adjustable vertically (spacing from the substrate) in order for example to be able to change from one bearing intermediate region to the next for the subsequent processing. In addition to the processing steps right through the substrate, further processing and/or monitoring steps for processing or monitoring the usable surface are advantageously carried out in the method. As the substrate rests with its back on bearing means during these steps, these further steps can be carried out unimpeded from the usable side. These processing and monitoring steps include for example the extraction of ablated material by suction, quality control, coating the usable surface, etc.

### BRIEF DESCRIPTION OF THE DRAWINGS

The invention will be described hereinafter in detail with reference to the figures, in which:

FIG. 1 shows a known arrangement of a processing installation for processing large, flat substrates from the back;

FIG. 2 shows a device according to the invention for processing large, flat substrates from the back; and

FIG. 3 shows the device according to FIG. 2, in which the movable bearings are displaced.

### DETAILED DESCRIPTION OF THE ILLUSTRATED EMBODIMENTS

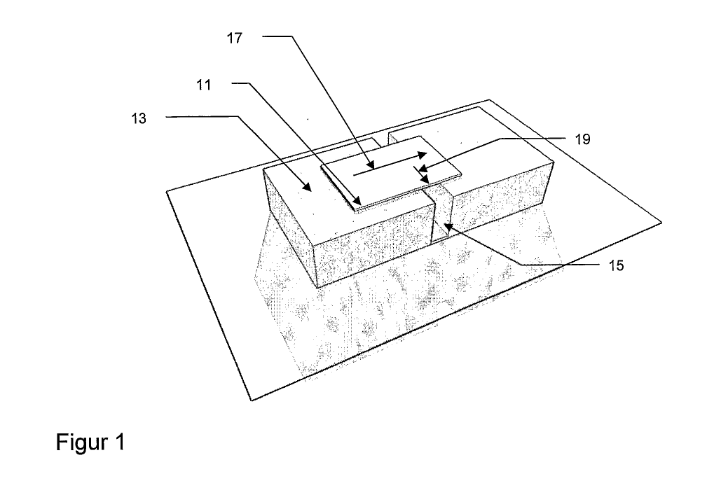

The known arrangement shown in FIG. 1 of a processing installation for processing large, flat substrates (11) from the back consists of a rest table (13) having a gap (15) in which the processing means can be attached. For processing, the substrate is moved on the rest table in the Y direction (arrow 17) and the laser arrangement carries out processing in the X direction (arrow 19).

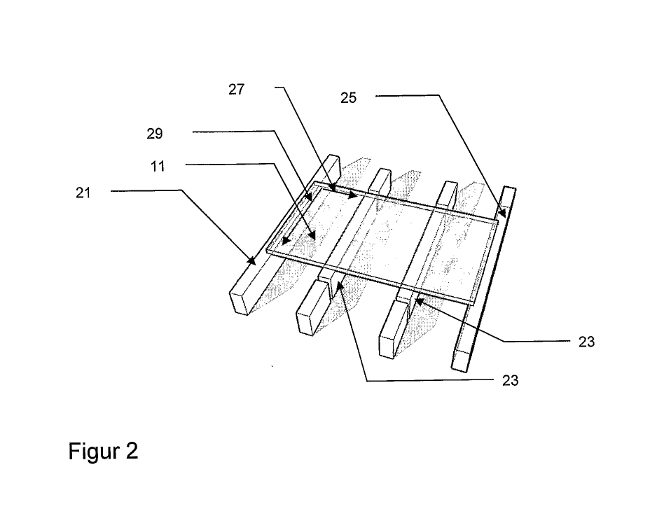

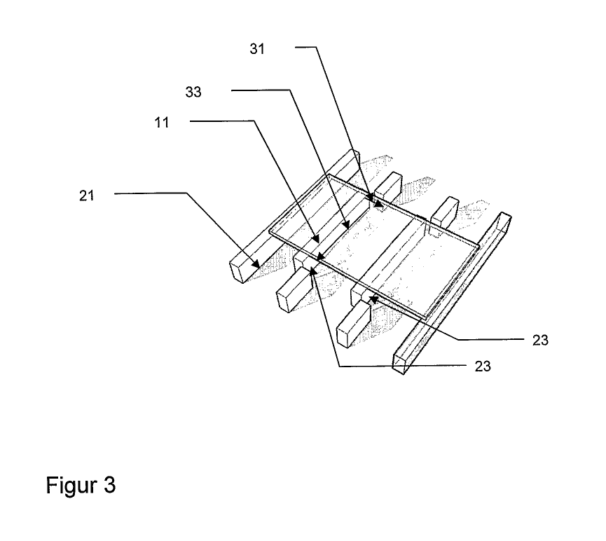

The device according to the invention shown in FIG. 2 for processing large, flat substrates (11) from the back consists of a plurality of linear bearing means (21, 23, 25) for the substrate between which processing from the back is possible right through the substrate. The processing means can be moved in the respective region between two bearing means in the X direction (arrow 27) and Y direction (arrow 29). The substrate 11 is mounted on a plurality of bearing means 21, 23, 25 arranged next to one another. These bearings may for example be simple rests, air bearings, rests with suction extraction, conveyor belts or a combination thereof. The spacing between the bearing means is selected in such a way that the sag of the substrate is minimal (<1 mm for laser structuring) and therefore restricts the precision of the processing of the back as little as possible. The processing can be carried out in the region of the usable surface next to the bearing means. In this case, the bearing means are moved both in the Y direction as indicated by arrow 29 and in the X direction as indicated by arrow 27. In order subsequently to process the regions of the usable surface that are covered by the bearing means, the bearing means 23 are displaced. FIG. 3 shows the device according to FIG. 2, in which the movable bearing means (23) are displaced in such a way that processing of the back in the regions which were covered by the bearing means in the starting position according to FIG. 2 is possible both in the Y direction (arrow 33) and in the X direction (arrow 31).

When the substrate is in the processing position, it is beneficial to arrest the substrate at at least 2 points, for example on the fixed bearing means 21, in order to avoid a displacement of the substrate 11 during the processing process and/or during the displacement of the movable bearing means 23. If a conveyor belt is used for mounting, a lowering of the bearing means or a slight raising of the substrate is beneficial before the displacement of the bearing means in order to avoid friction on the back of the substrate. This measure is not necessary in air bearings.

An alternative for achieving the same aim is an arrangement with a plurality of fixed bearings arranged in parallel and a means allowing the substrate 11 to be displaced by at least the bearing width in order to make the previously covered regions of the usable surface accessible for processing.

1. A device for processing a usable surface on a usable side of a glass substrate having a relatively large surface area, through the glass substrate, comprising:
at least three bearing means set apart from one another for receiving a glass substrate having a usable surface, a length or width greater than 0.5 m and a thickness less than 1 cm,
a movable processing means equipped with at least one laser source, for processing the usable surface of the substrate in at least two regions between the bearing means,
a displacement means for providing a relative displacement between the substrate and at least one of the at least three bearing means so that an entire usable surface of the substrate can be made accessible to the moveable processing means by a relative displacement or movement of at least one of the at least three bearing means in relation to the substrate.

2. The device according to claim 1, wherein the at least one laser source if configured for laser ablation and is configured for structuring thin-layer silicon solar modules.

3. The device according to claim 1, wherein the at least three or more bearing means comprises at least one non-terminal bearing means configured to be displaceable or movable so that an entire usable surface of the glass substrate can be made accessible to the processing means by displacing or moving the at least one non-terminal bearing means.

4. The device according to claim 3, further comprising a means for moving the at least one non-terminal bearing means.

5. The device according to claim 1, further comprising a conveying device configured for displacing the glass substrate by at least the width of the at least three bearing means so that the entire usable surface of the glass substrate can be made accessible to the processing means.

6. The device according to claim 1, wherein the processing means is movable in two intersecting directions, so that processing from the back of the glass substrate is possible in the at least two regions between the at least three bearing means.

7. The device according to claim 1, wherein the at least one laser source is configured to simultaneously process the usable surface of the glass substrate with at least one laser beam.

8. The device according to claim 1, wherein movement of the movable processing means and movement of the at least three bearing means are mechanically coupled.

9. A method for processing a usable surface extending on a usable side of a substrate, comprising:
fixing a substrate during a processing process so as to be positionally stable relative to at least three bearings, and
processing the substrate through the substrate opposite a usable surface of the substrate
processing regions of the usable surface that are covered by the bearings by displacing the relative position of the substrate in relation to at least one non-terminal bearing by at least a width of at least one of the bearings and processing the regions through the substrate.

10. The method according to claim 9, further comprising depositing the substrate on the at least three bearings in a spaced apart arrangement and further comprising processing the regions of the usable surface that are covered by the at least three bearings by displacing the relative position of the substrate in relation to at least one bearing by at least the width of the at least one bearing and by at most the spacing between the at least three bearings and processing the usable surface which has not yet been processed.

11. The method according to claim 9, further comprising holding the substrate in a fixed position and displacing the bearings in order to make previously covered regions of the usable surface accessible.

12. The method according to claim 9, further comprising holding the bearings in a fixed position and displacing the substrate in order to make previously covered regions of the usable surface accessible.

13. The method according to claim 9, further comprising displacing both the bearings and the substrate in order to make previously covered regions of the usable surface accessible.

14. The method according to claim 9, further comprising providing at least one laser source and moving the at least one laser source in two intersecting directions for processing the usable surface of the substrate.

15. The method according to claim 9, further comprising adjusting the processing with respect to a spacing from the back of the substrate in order to change from one intermediate region between two bearings to a next intermediate region.

16. The method according to claim 9, further comprising rotating the substrate between two processing steps about an axis perpendicular to the usable surface.

17. The method according to claim 9, further comprising monitoring the usable surface of the substrate resting on the bearings from either the usable side or the back of the substrate and processing the substrate according to the monitoring.

19. The device according to claim 1, wherein the at least three bearing means have at least one of an air cushion or a combination of an air cushion and suction extraction.

19. A device for processing a usable surface of a glass substrate, comprising;
a plurality of bearing devices set apart from one another and configured to receive a glass substrate having a relatively large usable surface;
at least one movable laser source configured to process the usable surface of the glass substrate through the glass substrate in at least two regions between the plurality of bearing devices;
a displacement device configured to provide relative displacement between the substrate and the plurality of bearing devices so that an entire usable surface of the glass substrate can be made accessible to the at least one moveable laser by a relative movement of the plurality of bearing devices relative to the glass substrate.

20. The device according to claim 19, wherein movement of the at least one movable laser source and movement of the plurality of bearing devices is mechanically coupled.
